(19) United States
(12) Patent Application Publication
(10) Pub. No.: US 2007/0294892 A1
(43) Pub. Date: Dec. 27, 2007

(54) Method for making a plate type heat pipe

(75) Inventors: Hsiuwei Yang, Taipei Hsien (TW); Pei-Pei Ding, Taipei Hsien (TW); Wenhwa Yu, Taipei Hsien (TW); Tsao-Hsiang Cheng, Taipei Hsien (TW)

Correspondence Address: PILLSBURY WINTHROP SHAW PITTMAN, LLP, P.O. BOX 10500, MCLEAN, VA, 22102, US

(73) Assignee: ASIA VITAL COMPONENTS CO., LTD., Kaohsiung City (TW)

(21) Appl. No.: 11/585,135

(22) Filed: Oct. 24, 2006

(30) Foreign Application Priority Data
Jun. 22, 2006 (TW) 095122501

(51) Int. Cl. B23P 15/26; B23P 6/00

(52) U.S. Cl. 29/890.032

(57) ABSTRACT

A method for making a plate type heat pipe includes the steps of: stacking a wick structure on a first plate, the wick structure defining a plurality of capillaries; high frequency welding the wick structure to the first plate; stacking a second plate on the wick structure; and connecting hermetically peripheral edges of the first and second plates together so as to form an enclosed cavity between the first and second plates for enclosing the wick structure.

### CROSS-REFERENCE TO RELATED APPLICATION

This application claims the priority of Taiwanese Application No. 095122501, filed on Jun. 22, 2006.

### BACKGROUND OF THE INVENTION

1. Field of the Invention

This invention relates to a method for making a plate type heat pipe, more particularly to a method involving securing a wick structure to a plate using high frequency welding techniques for making a plate type heat pipe.

2. Description of the Related Art

FIGS. 1 and 2 illustrate a conventional plate type heat pipe including a wick structure sandwiched between two opposite plates 11, and a working fluid (not shown) received in the heat pipe. One of the plates 11 is to be placed in direct contact with a heat source (not shown), such as a CPU or electronic components that can generate heat during operation, so as to transfer the heat therefrom to the working fluid through the wick structure. The wick structure includes a spacer 13 sandwiched between two opposite metal meshes 12. In order to prevent undesired separation of the wick structure from the plate 11 that is in contact with the heat source due to thermal expansion and to prevent poor connection between the metal meshes 12 and the spacer 13, after assembly of the metal meshes 12, the spacer 13, and the plates 11, the assembly is subjected to thermal treatment to enable diffusion bonding therebetween. However, prior to the thermal treatment, the metal meshes 12, the spacer 13 and the plates 11 are required to be precisely positioned using positioning and pressing means which are required to have a high flatness at the pressing side thereof. In addition, the thermal treatment normally takes 8-9 hours to achieve sufficient diffusion bonding among the components. For instance, in order to enhance thermal conduction, composite metal meshes are used for the metal meshes 11. The composite metal mesh normally includes a fine metal mesh and a coarse metal mesh connected to the fine metal mesh and having a mesh size larger than that of the fine metal mesh. The fine metal mesh is in direct contact with a contact portion of the plate 11 which is in direct contact with the heat source so as to expedite vaporization of the working fluid, while the coarse metal mesh facilitates flowing of the working fluid. The quality of the connection between the fine metal mesh and the coarse metal mesh is relatively important to the heat dissipating efficiency of the heat pipe.

### SUMMARY OF THE INVENTION

Therefore, the object of the present invention is to provide a method for making a plate type heat pipe that can overcome the aforesaid drawbacks of the prior art.

According to this invention, there is provided a method for making a plate type heat pipe. The method comprises: stacking a wick structure on a first plate, the wick structure defining a plurality of capillaries; high frequency welding the wick structure to the first plate; stacking a second plate on the wick structure; and connecting hermetically peripheral edges of the first and second plates together so as to form an enclosed cavity between the first and second plates for enclosing the wick structure.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is an exploded perspective view of a conventional plate type heat pipe;

FIG. 2 is a fragmentary schematic sectional view of the conventional plate type heat pipe;

FIG. 3 is a block diagram illustrating consecutive steps of a method for making the first preferred embodiment of a plate type heat pipe according to this invention;

FIG. 4 is a fragmentary schematic view of a wick structure of the first preferred embodiment;

FIG. 5 is a fragmentary schematic view of a wick structure of the second preferred embodiment;

FIG. 6 is a fragmentary schematic view of a wick structure of the third preferred embodiment;

FIG. 7 is a fragmentary schematic, partly sectional view to illustrate how a metal mesh is secured to a spacer of the first preferred embodiment using a welding device according to the method of this invention;

FIG. 8 is a fragmentary schematic, partly sectional view to illustrate how a metal mesh is secured to a spacer of the first preferred embodiment using a roller-type welding device according to the method of this invention; and

FIGS. 9 to 11 are fragmentary schematic, partly sectional views to illustrate consecutive steps of connecting a wick structure to plates of the plate type heat pipe of the first preferred embodiment according to the method of this invention.

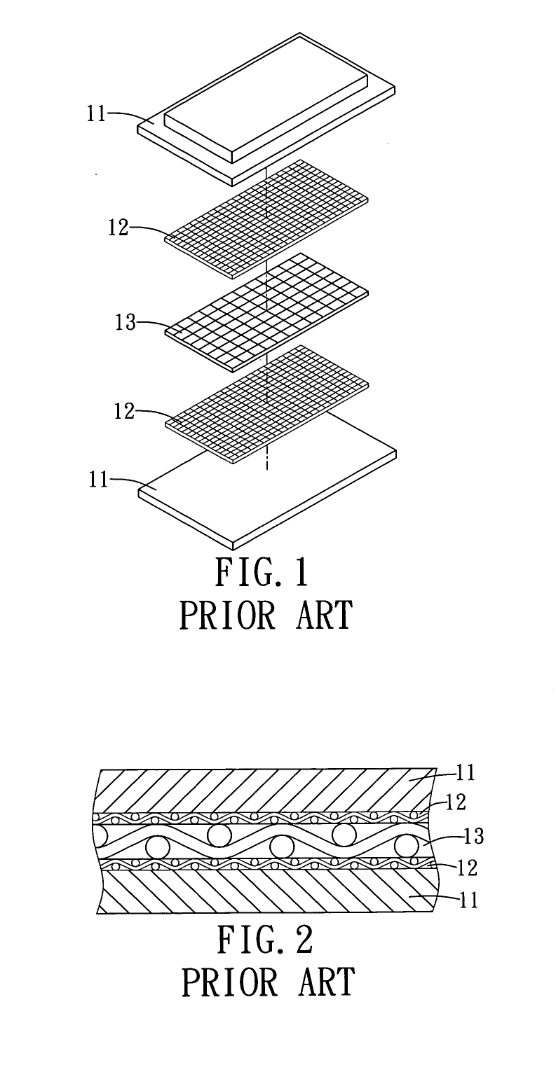

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

FIGS. 4 and 11 illustrate the first preferred embodiment of a plate type heat pipe according to this invention. The plate type heat pipe includes first and second plates 51, 52 and a wick structure 3 sandwiched between the first and second plates 51, 52 and defining a plurality of capillaries. The wick structure 3 includes a spacer 32 and a first metal mesh 31 wrapping around the spacer 32.

In this embodiment, the spacer 32 is in the form of a second metal mesh, and has first and second ends 321, 322, and first and second sides 323, 324 that extend between the first and second ends 321, 322. The first metal mesh 31 wraps around the spacer 32 so as to cover and contact the first and second sides 323, 324 and at least one of the first and second ends 321, 322 of the spacer 32 (only the first end 321 is brought into contact with the first metal mesh 31 in this embodiment).

The first and second plates 51, 52 have peripheral edges 511, 521 that are hermetically connected so as to form an enclosed cavity 30 between the first and second plates 51, 52 for enclosing the wick structure 3. A working fluid (not shown) is received in the cavity 30 for heat transfer by vaporization and by capillary mechanism. The second plate 52 is pressed to form at least one recess 35 for firmly positioning the wick structure 3 and the first and second plates 51, 52 and for securing the connection between the first metal mesh 31 and the spacer 32.

Preferably, the first metal mesh 31 and the spacer 32 are made from copper. The first metal mesh 31 has a mesh size smaller than that of the second metal mesh of the spacer 32. Preferably, the first and second plates 51, 52 are made from a metallic material selected from the group consisting of aluminum and copper.

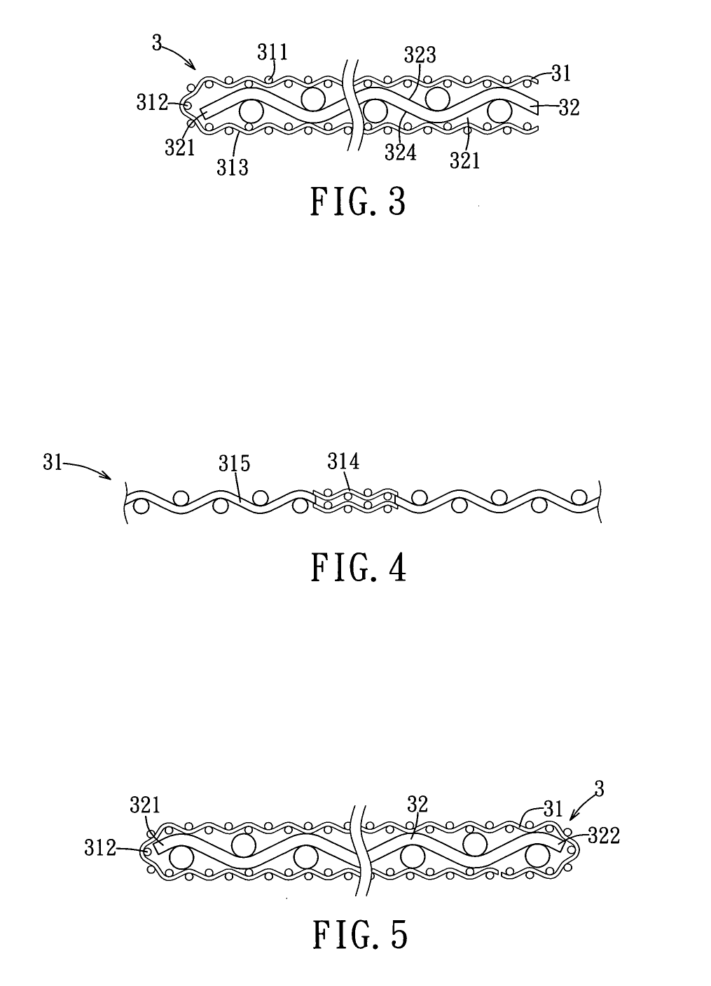

FIGS. 3, 4, and 9-11 illustrate the consecutive steps of a method for making the first preferred embodiment of the plate type heat pipe according to this invention.

The method includes the steps of: wrapping the spacer 32 with the first metal mesh 31 in such a manner that the first metal mesh 31 is folded into first and second portions 311, 313 and a bent portion 312 interconnecting the first and second portions 311, 313, that the first portion 311 covers the first side 323 of the spacer 32, that the second portion 313 covers the second side 324 of the spacer 32, and that the bent portion 312 covers the first end 321 of the spacer 32 (see FIG. 4); securing the first metal mesh 31 to the spacer 32 so as to form the wick structure 3; stacking the wick structure 3 on the first plate 51 (see FIG. 9); high frequency welding the wick structure 3 to the first plate 51 through supersonic welding techniques; stacking the second plate 52 on the wick structure 3 (see FIG. 10); pressing the second plate 52 against the wick structure 3 and the first plate 51 so as to form the recess 35 therein (see FIG. 10); bending the peripheral edge 521 of the second plate 52 into an L-shaped structure (see FIG. 11); and connecting hermetically the peripheral edges 511, 521 of the first and second plates 51, 52 together so as to form the enclosed cavity 30 (see FIG. 11) between the first and second plates 51, 52 for enclosing the wick structure 3.

In this embodiment, the first metal mesh 31 is welded to the spacer 32 through high frequency welding techniques, and the peripheral edges 511, 521 of the first and second plates 51, 52 are welded together through high frequency welding techniques. Alternatively, the peripheral edges 511, 521 of the first and second plates 51, 52 can be jointed together by forming a metallic joint therearound by vapor deposition techniques, followed by heating the metallic joint and the first and second plates 51, 52 so as to enable eutectic fusion to thereby fuse them together. The metallic joint is preferably made from a material selected from the group consisting of Sn, Ag, Cu, Pb, Bi, and combinations thereof.

FIG. 7 illustrates how the first metal mesh 31 is welded to the spacer 32 using a spot-welding type high frequency welding device. The high frequency welding device includes a head 41, a toothed upper mold 42, and a lower mold 44. During the welding operation, the spacer 32 wrapped with the first metal mesh 31 is sandwiched tightly between the upper and lower molds 42, 44 so that the contact areas between the spacer 32 and the first metal mesh 31 rub vigorously each other when the upper mold 42 vibrates, which results in the contact areas being fused together.

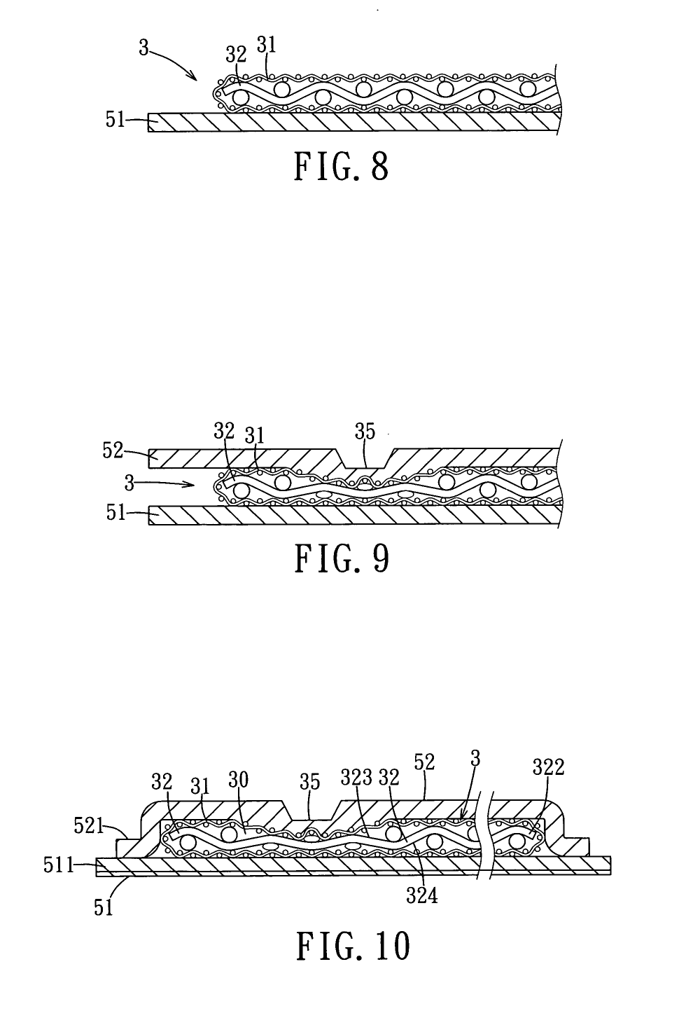

FIG. 8 illustrates the welding operation of the first metal mesh 31 and the spacer 32 using another spot-welding type high frequency welding device. The high frequency welding device includes upper and lower toothed roller molds 45, 47 which vibrate and which rotate in opposite rotation directions during the welding operation.

FIG. 5 illustrates the second preferred embodiment of the plate type heat pipe according to this invention. This embodiment differs from the previous embodiment in that the first metal mesh 31 is in the form of a composite metal mesh which includes a primary metal mesh 315 and two secondary metal meshes 314 attached securely to two opposite sides of the primary metal mesh 315 and having a mesh size less than that of the primary metal mesh 315. At least one of the secondary metal meshes 314 serves to contact directly a portion of the second plate 52 that is to be placed in direct contact with a heat source so as to enhance vaporization of the working fluid in the cavity 30 at the vicinity of the portion of the second plate 52, while the primary metal mesh 315 serves to facilitate flowing of the working fluid in the cavity 30 from one end to the other end thereof.

In this embodiment, the primary and secondary metal meshes 315, 314 are made from copper, and the secondary metal meshes 314 are secured to the primary metal mesh 315 through high frequency welding techniques.

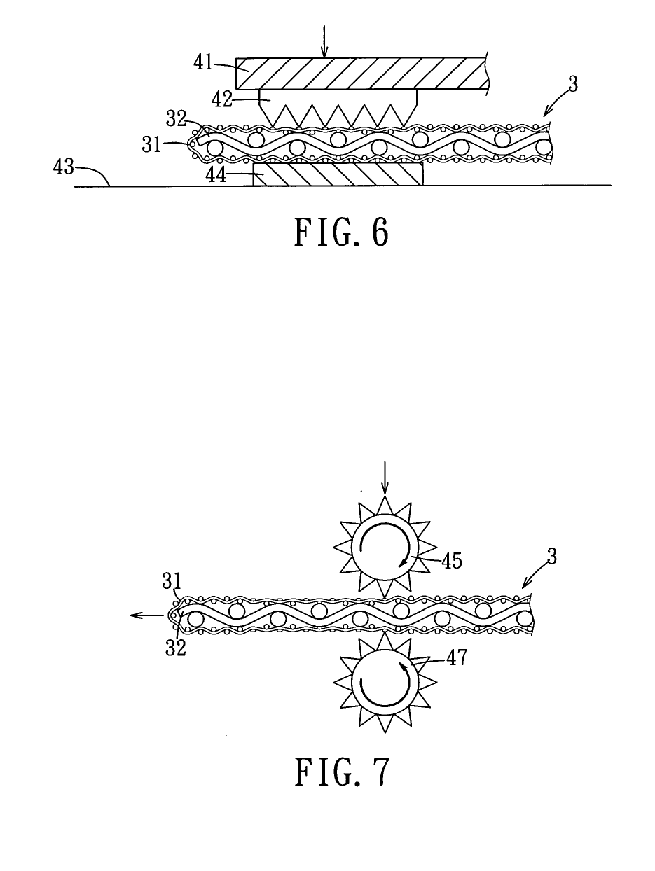

FIG. 6 illustrates a wick structure of the third preferred embodiment of the plate type heat pipe according to this invention. This embodiment differs from the first preferred embodiment in that the entire spacer 32 is wrapped with the first metal mesh 31. Hence, the second end 322 of the spacer 32 is also covered and contacts the first metal mesh 31.

By using high frequency welding techniques to weld the wick structure 3 to at least one of the first and second plates 51, 52 when making the heat pipe of this invention, the aforesaid drawbacks associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for making a plate type heat pipe, comprising:
stacking a wick structure on a first plate, the wick structure defining a plurality of capillaries;
high frequency welding the wick structure to the first plate;
stacking a second plate on the wick structure; and
connecting hermetically peripheral edges of the first and second plates together so as to form an enclosed cavity between the first and second plates for enclosing the wick structure.

2. The method of claim 1, further comprising:
wrapping a spacer with a first metal mesh; and
securing the first metal mesh to the spacer so as to form the wick structure.

3. The method of claim 2, wherein the spacer has first and second ends, and first and second sides that extend between the first and second ends, the first metal mesh wrapping around the spacer so as to cover and contact the first and second sides and at least one of the first and second ends of the spacer.

4. The method of claim 2, wherein the first metal mesh is welded to the spacer through high frequency welding techniques.

5. The method of claim 1, wherein the peripheral edges of the first and second plates are welded together through high frequency welding techniques.

6. The method of claim 2, wherein the spacer is in the form of a second metal mesh.

7. The method of claim 6, wherein the second metal mesh is made from copper.

8. The method of claim 7, wherein the first metal mesh is made from copper and has a mesh size smaller than that of the second metal mesh.

9. The method of claim 1, wherein the first and second plates are made from a metallic material selected from the group consisting of aluminum and copper.

10. The method of claim 1, wherein the wick structure includes a composite mesh that has a primary metal mesh and a secondary metal mesh attached securely to the primary metal mesh.

11. The method of claim 10, wherein the primary metal mesh and the secondary metal mesh are made from copper.

12. The method of claim 10, wherein the secondary metal mesh is secured to the primary metal mesh through high frequency welding techniques.
